(19) United States
(12) Patent Application Publication
(10) Pub. No.: US 2025/0254216 A1
(43) Pub. Date: Aug. 7, 2025

(54) SYSTEM AND METHOD FOR PROVIDING SEAMLESS CONTENT STREAMING SERVICE BETWEEN DIFFERENT DEVICES AND CONTENT STREAMING DEVICE THEREFOR

(71) Applicants: Hyundai Motor Company, Seoul (KR); Kia Corporation, Seoul (KR)

(72) Inventor: Seung Woo Lee, Incheon (KR)

(21) Appl. No.: 18/798,489

(22) Filed: Aug. 8, 2024

(30) Foreign Application Priority Data
Feb. 1, 2024 (KR) 10-2024-0015973

(51) Int. Cl. H04L 67/12; H04N 21/20

(52) U.S. Cl. CPC H04L 67/12; H04N 21/20

(57) ABSTRACT

An embodiment content streaming device implemented to seamlessly stream content being streamed from a second content streaming device includes a first communication module configured to receive first metadata for the content being streamed by the second content streaming device, a second communication module configured to communicate with a content providing server, and a processor configured to request content corresponding to the first metadata from the content providing server and, in response to receiving content from the content providing server in response to the request, stream the received content.

### CROSS-REFERENCE TO RELATED APPLICATIONS

This application claims the benefit of Korean Patent Application No. 10-2024-0015973, filed on Feb. 1, 2024, which application is hereby incorporated herein by reference.

### TECHNICAL FIELD

The disclosure relates to a system, method, and device for providing a seamless content streaming service between different devices.

### BACKGROUND

Recently, there has been a diversification of services that offer various digital content, including music, movies, and broadcasts, through streaming methods. Content service users can stream content provided by content service providers (CSPs) through the service delivery platforms established by the CSPs.

Examples of content service delivery platforms include Melon™, Genie™, Apple Music™, and Watcha™.

Content service users have primarily used personal electronic devices (e.g., smartphones, personal computers (PCs), etc.) to access content services, but recently, systems have been installed in vehicles to allow the use of content services.

Content service users must register their user identification information through the subscription process to access content services and register with the content service provider's server.

Currently, content delivery services through personal devices and vehicles are not unified.

Therefore, even if content service users have set up their user identification information for using the content service through personal electronic devices, they still need to set up additional user identification information in order to use the content service through a vehicle.

This means that there is a limitation that content streamed through personal electronic devices cannot be synchronized with the vehicle to continue streaming if the user identification information for using the content service through personal electronic devices and the user identification information for using the content service through the vehicle exist separately.

This background technology constitutes information the inventor possessed for the derivation of the disclosure or acquired during development and does not necessarily constitute publicly known prior art.

### SUMMARY

The disclosure relates to a system, method, and device for providing a seamless content streaming service between different devices. Particular embodiments relate to a system, method, and device for synchronizing content streaming services provided on different devices to allow content streamed on one device to be streamed seamlessly on another device.

The embodiments disclosed herein provide a system, method, and device for synchronizing content streaming services provided on different devices to allow content streamed on one device to be streamed seamlessly on another device.

The embodiments disclosed herein also provide a system, method, and device capable of seamless streaming of content even when different devices use different platforms for content streaming services.

The embodiments disclosed herein also provide a system, method, and device capable of seamless streaming of content using content stored in memory, without being limited to platforms providing content streaming services.

The technical embodiments of this disclosure are not limited to the aforesaid, and other embodiments not described herein can be clearly understood by those skilled in the art from the descriptions below.

The above embodiments can be accomplished by providing a system, method, and device that are capable of synchronizing content streaming services provided by different devices, allowing content streamed on one device to be seamlessly streamed on another device.

A device according to an embodiment of the disclosure may be a content streaming device implemented to seamlessly stream content being streamed from another content streaming device.

According to an embodiment, the device may include a first communication module configured to receive first metadata for content being streamed by the other content streaming device, a second communication module configured to communicate with at least one content providing server, and a processor configured to request content corresponding to the first metadata from the at least one content providing server and stream, based on receiving content from the at least one content providing server in response to the request, the received content.

According to an embodiment, the processor may receive the content from a single content providing server and stream the received content.

According to an embodiment, the single content providing server may be identical to or different from the server providing the content to the other content streaming device.

According to an embodiment, the processor streams, upon receiving contents from multiple content providing servers, the content selected based on priorities.

According to an embodiment, the multiple content providing servers include or exclude the server providing the content to the other content streaming device.

According to an embodiment, the processor may compare the first metadata with second metadata received along with the content from the multiple content providing servers and stream the content matched with the second metadata identical to the first metadata.

According to an embodiment, the processor may stream the content received first in the absence of second metadata identical to the first metadata.

According to an embodiment, the processor may search, based on failure of receiving content from the at least one content providing server, for the content corresponding to the first metadata in internal memory and stream the searched content.

According to an embodiment, the processor determines, based on the absence of the content corresponding to the first metadata in the internal memory, whether an external memory is attached, and based on an external memory being attached, searches for the content corresponding to the first metadata in the external memory and streams the searched content.

A method according to an embodiment of the disclosure may be a method for seamlessly streaming content streamed from a first content streaming device on a second content streaming device.

According to an embodiment, the method may include providing first metadata for the content being streamed by the first content streaming device to the second content streaming device, requesting, at the second content streaming device, content corresponding to the first metadata from at least one content providing server, and streaming, based on the second content streaming device receiving content from the at least one content providing server in response to the request, the received content.

According to an embodiment, the streaming may include receiving content from a single content providing server and streaming the received content.

According to an embodiment, the single content providing server may be identical to or different from the server providing content to the first content streaming device.

According to an embodiment, the streaming may include streaming content selected based on priorities of the contents provided from multiple content providing servers.

According to an embodiment, the multiple content providing servers may include or exclude the server providing the content to the first content streaming device.

According to an embodiment, the streaming of content selected based on priorities may include comparing the first metadata with second metadata received along with the content from the multiple content providing servers and streaming the content matched with the second metadata identical to the first metadata.

According to an embodiment, the streaming of content selected based on priorities may include streaming the content received first based on absence of second metadata identical to the first metadata.

According to an embodiment, the processor may search, based on failure of receiving content from the at least one content providing server, for the content corresponding to the first metadata in internal memory and stream the searched content.

According to an embodiment, the method may further include determining, at the second content streaming device, whether an external memory is attached, based on the absence of the content corresponding to the first metadata in the internal memory, searching, based on an external memory being attached, for the content corresponding to the first metadata in the external memory, and streaming the searched content.

A system according to an embodiment of the disclosure may include at least one content providing server, a first content streaming device configured to stream content provided by the at least one content providing server, and a second content streaming device.

According to an embodiment, the second content streaming device may receive first metadata for content being streamed by the first content streaming device, request content corresponding to the first metadata from the at least one content providing server, and stream, based on receiving content from the at least one content providing server in response to the request, the received content.

According to an embodiment, the first content streaming device may include a portable electronic device, and the second content streaming device may include a content delivery device installed in a vehicle.

Additional details regarding various embodiments of the disclosure, beyond what has been described as solutions to the problems, are provided in the following descriptions and drawings.

According to an embodiment disclosed herein, it is possible to synchronize content streaming services provided on different devices, allowing content streamed on one device to be seamlessly streamed on another device.

According to an embodiment disclosed herein, it is possible to seamlessly stream content even when different devices use different platforms for content streaming services.

According to an embodiment disclosed herein, it is possible to provide a method for seamlessly streaming content using content stored in memory, without being limited to platforms providing content streaming services.

Therefore, users can easily access content services without the hassle of actively synchronizing content streamed on one device for seamless streaming on another device.

The advantageous effects of embodiments of this disclosure are not limited to the aforesaid, and other effects not described herein can be clearly understood by those skilled in the art from the descriptions below.

The content of the problem to be solved, the means for solving the problem, and the effects mentioned above are not essential features of the claims, so the scope of the claims is not limited by the content disclosed in the disclosure.

### BRIEF DESCRIPTION OF THE DRAWINGS

The drawings attached below are provided to help understand the embodiments of the disclosure, along with detailed explanations. However, the technical features of the embodiments are not limited to a specific drawing, and the features disclosed in each drawing can be combined to form new embodiments.

FIG. 1 is a diagram illustrating a configuration of a system for providing seamless streaming services between devices according to an embodiment of the disclosure;

FIG. 2 is a diagram illustrating a configuration of a first content streaming device according to an embodiment of the disclosure;

FIG. 3 is a diagram illustrating a configuration of a second content streaming device according to an embodiment of the disclosure; and

FIGS. 4 and 5 illustrate a flowchart of a method for providing seamless content streaming services between different devices according to an embodiment of the disclosure.

### DETAILED DESCRIPTION OF ILLUSTRATIVE EMBODIMENTS

Advantages and features of embodiments of the disclosure and methods of accomplishing the same may be understood more readily by reference to the following detailed description of exemplary embodiments and the accompanying drawings. The disclosure can, however, be embodied in many different forms and should not be construed as being limited to the embodiments set forth herein; rather, these embodiments are provided so that the disclosure will be thorough and complete and will fully convey the concept of the disclosure to those skilled in the art, and the disclosure will only be defined by the appended claims.

The shapes, sizes, ratios, angles, numbers, and the like illustrated in the drawings to describe embodiments of the disclosure are merely exemplary, and thus, the disclosure is not limited thereto. Throughout the specification, the same reference numerals refer to the same components. In addition, detailed descriptions of well-known technologies may be omitted in the disclosure to avoid obscuring the subject matter of the disclosure. In this specification, when terms such as “includes,” “has,” and “comprises” are used, other elements may be added unless the term “only” is used. Unless otherwise explicitly stated, when a component is expressed in the singular form, it is intended to encompass the plural form as well.

In interpreting the components, it is construed to include a margin of error even in the absence of explicit description.

When a description involves a temporal relationship, such as “later,” “subsequently,” “next,” and “before,” non-consecutive situations may also be included unless the terms “immediately” or “directly” are used.

Although the terms “first,” “second,” and the like are used for describing various components, these components are not confined by these terms. These terms are merely used for distinguishing one component from the other components. Therefore, the first component mentioned hereinafter may be the second component in the technical sense of the disclosure.

When describing the components of the disclosure, terms such as “first,” “second,” “A,” “B,” “(a),” and “(b)” can be used. These terms are only used only to distinguish one component from another, and the nature, sequence, order, or quantity of the corresponding components are not limited by the term. When a component is described as being “connected,” “coupled,” or “joined” to another component, it should be understood that the component can be directly connected or joined to the other component, or another component may be “interposed” between them, unless explicitly stated otherwise.

When a component is described as “at least one” it should be understood that all possible combinations of one or more of the related components are encompassed. For example, the phrase “at least one of the first, second, and third components” means it includes not only the first, second, or third component individually but also any combination of two or more components among the first, second, and third components.

The various features of the embodiments of the disclosure can be combined or assembled together, either partially or entirely, in a technically diverse manner, and each embodiment can be independently implemented or implemented in conjunction with related embodiments.

Hereinafter, descriptions are made of the system and method for providing seamless streaming services between different devices according to embodiments of the disclosure with reference to the accompanying drawings.

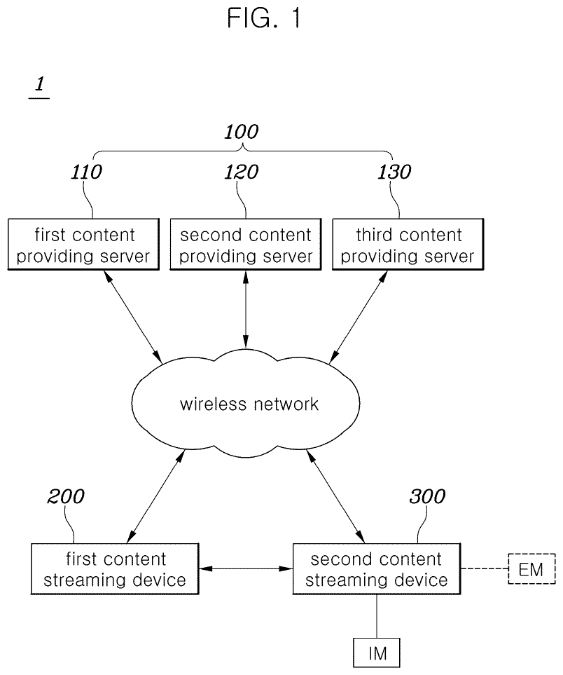

FIG. 1 is a diagram illustrating a configuration of a system 1 for providing seamless streaming services between devices according to an embodiment of the disclosure.

With reference to FIG. 1, the system for providing seamless content streaming services between different devices according to an embodiment of the disclosure (hereinafter, the service providing system 1) may include at least one content providing server 100, a first content streaming device 200, and a second content streaming device 300.

In this embodiment, although three content providing servers 110, 120, and 130 are exemplified as being configured within the service providing system 1, it is possible for four or more content providing servers 100 to be configured within the service providing system 1.

The three content providing servers 110, 120, and 130 may provide content through different platforms. For example, the first content providing server 110 may provide content through a first platform, the second content providing server 120 may provide content through a second platform, and the third content providing server 130 may provide content through a third platform.

A content service user may set up user identification information through the registration process for accessing content streaming services, and the user identification information may be registered with the content providing servers.

The content service user may receive a content streaming service using the first content streaming device 200 and may also receive the content streaming service using the second content streaming device 300.

The first content streaming device 200 may stream content provided by any of the first to third content providing servers 110, 120, and 130 that it is linked to.

The second content streaming device 300 may stream content provided by any of the first to third content providing servers 110, 120, and 130 with which it is linked.

The first content streaming device 200 may be linked to any of the first to third content providing servers 110, 120, and 130 based on preset user identification information.

For example, the first content streaming device 200 may be linked to the first content providing server 110 based on the preset first-1 user identification information (ID1-1), linked to the second content providing server 120 based on the preset first-2 user identification information (ID1-2), and linked to the third content providing server 130 based on the preset first-3 user identification information (ID1-3).

The second content streaming device 300 may be linked to any of the first to third content providing servers 110, 120, and 130 based on preset user identification information.

For example, the second content streaming device 300 may be linked to the first content providing server 110 based on the preset second-1 user identification information (ID2-1), linked to the second content providing server 120 based on the preset second-2 user identification information (ID2-2), and linked to the third content providing server 130 based on the preset second-3 user identification information (ID2-3).

According to an embodiment, the content providing servers supplying content to the first and second content streaming devices 200 and 300 may be identical. According to an embodiment, the content providing servers supplying content to the first and second content streaming devices 200 and 300 may differ.

The first and second content streaming devices 200 and 300 may be configured in a mode for accessing the service according to an embodiment of the disclosure.

The mode for accessing the service according to an embodiment of the disclosure may be referred to as the “inter-device streaming mode.”

The content provided through the service according to an embodiment of the disclosure may include music, but the type of content is not limited thereto.

The following describes, by way of example, the seamless streaming of content being streamed by the first content streaming device 200 through the second content streaming device 300.

The first content streaming device 200 may be a portable electronic device (e.g., a smartphone), and the second content streaming device 300 may be a content providing device installed in a vehicle (e.g., a head unit).

At least one of the content providing servers 110, 120, and 130 linked to the first content streaming device 200 may provide content requested by the first content streaming device 200 to the first content streaming device 200.

For convenience of explanation, it is assumed that the first content providing server 110 is linked to the first content streaming device 200 and provides content to the first content streaming device 200.

The first content providing server 110 may provide metadata related to the content requested by the first content streaming device 200 to the first content streaming device 200.

When the streaming content is music, the metadata may include, but is not limited to, platform information, artist information, title information, and album information.

At least one of the content providing servers 110, 120, and 130 linked to the second content streaming device 300 may receive metadata provided by the second content streaming device 300 and may provide content corresponding to the received metadata to the second content streaming device 300.

At least one of the content providing servers 110, 120, and 130 that has received the metadata may provide metadata including its platform information while providing content.

The first content streaming device 200 may request content from the first content providing server 110 that it is linked to, among the content providing servers 110, 120, and 130, and may stream the content provided in response to the request.

The first content streaming device 200 may receive metadata related to the streaming content from the first content providing server 110.

In the case of being linked to the second content streaming device 300, the first content streaming device 200 may provide metadata related to the currently streaming content to the second content streaming device 300.

According to an embodiment, the first content streaming device 200 may be set in “inter-device streaming mode.” The first content streaming device 200 set in “inter-device streaming mode” may automatically link with the second content streaming device 300 according to a predetermined method.

For example, the first content streaming device 200 may automatically link with the second content streaming device 300 via Bluetooth™ communication.

For example, the first content streaming device 200 may provide metadata related to the currently streaming content to the second content streaming device 300 based on the Bluetooth audio/video remote control profile (AVRCP) meta service.

When linked with the first content streaming device 200, the second content streaming device 300 may request and receive metadata related to the content being streamed by the first content streaming device 200 in response to a request.

According to an embodiment, the second content streaming device 300 may be set to ‘inter-device streaming mode.’ When set to ‘inter-device streaming mode,’ the second content streaming device 300 may automatically link with the first content streaming device 200 according to a predetermined method.

For example, the second content streaming device 300 may automatically link with the first content streaming device 200 via Bluetooth communication.

For example, the second content streaming device 300 may receive metadata related to the currently streaming content from the first content streaming device 200 based on the Bluetooth audio/video remote control profile (AVRCP) meta service.

The second content streaming device 300 may provide at least one of the content providing servers 110, 120, and 130 that it is linked to with metadata in order to request content corresponding to the metadata and may receive the content provided in response to the request.

According to an embodiment, the second content streaming device 300 may be linked to one or more content providing servers based on the user's settings.

According to an embodiment, the second content streaming device 300 may or may not receive content from one or more linked content providing servers.

According to an embodiment, the second content streaming device 300 may receive content from one or more linked content providing servers and may also receive metadata from the content providing servers that supply the content.

The metadata provided by the content providing servers may include, but is not limited to, platform information, artist information, title information, and album information.

For example, the second content streaming device 300 may convert the metadata into a suitable format for providing to the content providing server 100.

According to an embodiment, the second content streaming device 300 may stream the received content. The second content streaming device 300 may also store the received content in its internal memory IM. Meanwhile, when it fails to receive content, the second content streaming device 300 may output streaming failure information.

According to an embodiment, when the second content streaming device 300 receives content from multiple content providing servers 100, it may determine the content to output based on predetermined priority criteria such as metadata and reception order.

Initially, the second content streaming device 300 may compare the metadata received from the first content streaming device 200 (referred to as first metadata) with the metadata matched to the received content (referred to as second metadata).

The second content streaming device 300 may determine content matched with the second metadata, which is identical to the first metadata, as the output target and stream that content.

Subsequently, when there is no identical second metadata corresponding to the first metadata, the second content streaming device 300 may determine the first received content as the output target and stream that content.

According to an embodiment, the second content streaming device 300 may conduct a search to determine whether content corresponding to the metadata is stored in its internal memory IM.

For example, the second content streaming device 300 may search its internal memory IM for content not provided from the content providing server 100.

The second content streaming device 300 may stream content stored in its internal memory IM.

When the second content streaming device 300 fails to receive content from the content providing server 100 and determines that content corresponding to the metadata is not stored in its internal memory IM, it may output streaming failure information.

According to an embodiment, when the second content streaming device 300 has external memory EM attached, it may conduct a search to determine whether content corresponding to the metadata is stored in the external memory EM.

For example, even though the external memory EM is attached, when the second content streaming device 300 fails to receive content from the content providing server 100 and determines that content corresponding to the metadata is not stored in its internal memory IM, it may proceed to search the external memory EM.

The second content streaming device 300 may determine content stored in the external memory EM as the output target and stream that content.

When the second content streaming device 300 fails to receive content from the content providing server 100 and determines that content corresponding to the metadata is not stored in either its internal memory IM or external memory EM, it may output streaming failure information.

In this way, the second content streaming device 300 may acquire multiple instances of the same content through different devices for streaming. Therefore, it is necessary to select one content from multiple identical contents, and a prioritization method may be set in the second content streaming device 300.

The disclosed embodiment may be applicable to smartphones and vehicles. In this case, the smartphone may correspond to the first content streaming device 200, while the head unit of the vehicle may correspond to the second content streaming device 300.

For example, when a content service user enters a vehicle with the smartphone that is streaming content, the head unit of the vehicle may obtain the metadata of the content through communication with the smartphone, and based on the obtained metadata, the head unit may request the content from the content providing server 100 and stream the content provided by the content providing server 100.

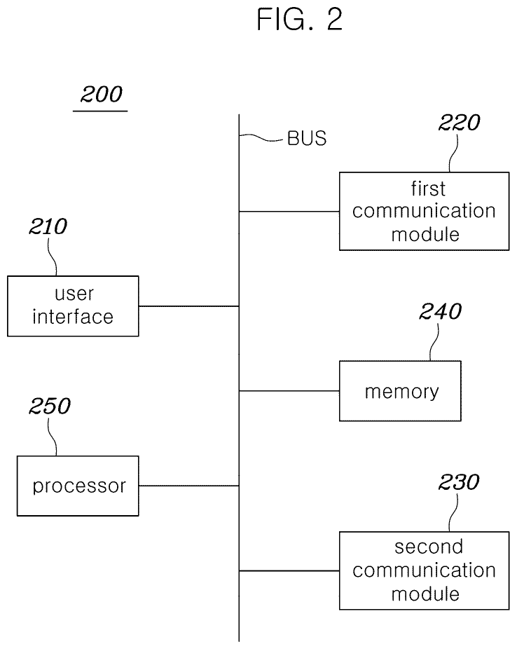

FIG. 2 is a diagram illustrating a configuration of a first content streaming device 200 according to an embodiment of the disclosure.

With reference to FIGS. 1 and 2, the first content streaming device 200 according to an embodiment of the disclosure may include a user interface 210, a first communication module 220, a second communication module 230, a memory 240, and a processor 250, and the configuration of the first content streaming device 200 is not limited thereto.

The processor 250 may be connected to the user interface 210, the first communication module 220, the second communication module 230, and the memory 240 via an internal bus.

The user interface 210 may receive various information or instructions from the user and may output information provided by the processor 250 according to the operation of the first content streaming device 200.

Information or instructions input through the user interface 210 may be transmitted to the processor 250. For example, the user interface 210 may transmit a mode (inter-device streaming mode) set by the user to the processor 250.

The first communication module 220 may be configured for communication with the content providing server 100, while the second communication module 230 may be configured for communication with the second content streaming device 300.

For example, the first communication module 220 may communicate with the content providing server 100 via a wireless network according to a predetermined communication method.

According to an embodiment, the first communication module 220 may receive streaming content and content-related metadata from the content providing server 100 and transmit the content and metadata to the processor 250.

For example, the second communication module 230 may perform short-range wireless communication with the second content streaming device 300 based on the configured communication method.

According to an embodiment, the second communication module 230 may perform communication based on Bluetooth technology to transmit content-related metadata to the second content streaming device 300.

The memory 240 may store various algorithms, data, and other information necessary for the operation of the processor 250.

The memory 240 may include volatile memory and/or non-volatile memory. The volatile memory may include dynamic random access memory (DRAM), static RAM (SRAM), synchronous DRAM (SDRAM), phase-change RAM (PRAM), magnetic RAM (MRAM), resistive RAM (RRAM), and ferroelectric RAM (FeRAM). The non-volatile memory may include read-only memory (ROM), programmable ROM (PROM), electrically programmable ROM (EPROM), electrically erasable programmable ROM (EEPROM), and flash memory.

The memory 240 may store algorithms for providing the content streaming service according to an embodiment of the disclosure. For example, the memory 240 may store algorithms related to interoperation with the second content streaming device 300.

The processor 250 may perform the content streaming service based on the algorithms and data stored in the memory 240, instructions or information input through the user interface 210, and information received through the first communication module 220.

The processor 250 may be implemented as a hardware data processing device with a circuit having a physical structure to execute desired operations. For example, the desired operations may encompass codes or instructions included in the program.

For example, the hardware-implemented data processing device may encompass microprocessors, central processing units (CPUs), processor cores, multi-core processors, multiprocessors, application-specific integrated circuits (ASICs), and field programmable gate arrays (FPGAs).

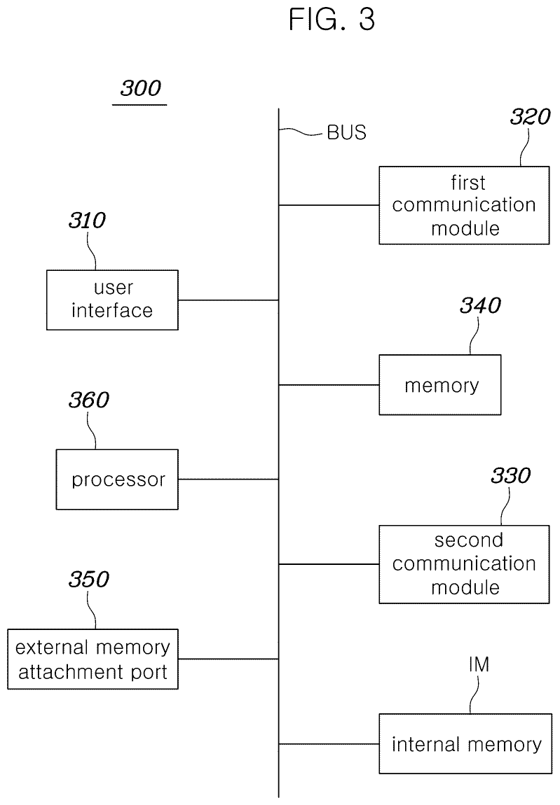

FIG. 3 is a diagram illustrating a configuration of a second content streaming device 300 according to an embodiment of the disclosure.

With reference to FIGS. 1 and 3, the second content streaming device 300 according to an embodiment of the disclosure may include a user interface 310, a first communication module 320, a second communication module 330, a memory 340, an external memory attachment port 350, an internal memory IM, and a processor 360, and the configuration of the second content streaming device 300 is not limited thereto.

The processor 360 may be connected to the user interface 310, the first communication module 320, the second communication module 330, the memory 340, the external memory attachment port 350, and the internal memory IM via an internal bus.

The user interface 310 may receive various information or instructions from the user and may output information provided by the processor 360 according to the operation of the second content streaming device 300.

For example, the user interface 310 may include an audio output module through which content (e.g., music) may be output.

Information or instructions input through the user interface 310 may be transmitted to the processor 360. For example, the user interface 310 may transmit a mode (inter-device streaming mode) set by the user to the processor 360.

The first communication module 320 may be configured for communication with the content providing server 100, while the second communication module 330 may be configured for communication with the first content streaming device 200.

For example, the first communication module 320 may communicate with the content providing server 100 via a wireless network according to a predetermined communication method.

According to an embodiment, the first communication module 320 may transmit content-related metadata to the content providing server 100 and relay streaming content and server-related metadata provided by the content providing server 100 to the processor 360.

For example, the second communication module 330 may perform short-range wireless communication with the first content streaming device 200 based on the configured communication method.

According to an embodiment, the second communication module 330 may perform communication based on Bluetooth technology to request streaming content-related metadata from the first content streaming device 200 and receive streaming content-related metadata provided by the first content streaming device 200.

The memory 340 may store various algorithms, data, and other information necessary for the operation of the processor 360.

The memory 340 may include volatile memory and/or non-volatile memory. The volatile memory may include dynamic random access memory (DRAM), static RAM (SRAM), synchronous DRAM (SDRAM), phase-change RAM (PRAM), magnetic RAM (MRAM), resistive RAM (RRAM), and ferroelectric RAM (FeRAM). The non-volatile memory may include read-only memory (ROM), programmable ROM (PROM), electrically programmable ROM (EPROM), electrically erasable programmable ROM (EEPROM), and flash memory.

The memory 340 may store algorithms for providing the content streaming service according to an embodiment of the disclosure. For example, the memory 340 may store algorithms related to interoperation with the first content streaming device 200. For example, the memory 340 may store a content-related prioritization algorithm.

The external memory attachment port 350 may be configured for attaching external memory EM, and when the external memory EM is attached to the external memory attachment port 350, the external memory attachment port 350 may output a signal to the processor 360 to indicate the attachment of the external memory EM.

The internal memory IM may store contents that may be played back by the second content streaming device 300.

The processor 360 may perform the content streaming service based on the algorithms and data stored in the memory 340, instructions or information input through the user interface 310, and information received through the first and second communication modules 320 and 330.

The processor 360 may be implemented as a hardware data processing device with a circuit having a physical structure to execute desired operations. For example, the desired operations may encompass codes or instructions included in the program.

For example, the hardware-implemented data processing device may encompass microprocessors, central processing units (CPUs), processor cores, multi-core processors, multiprocessors, application-specific integrated circuits (ASICs), and field programmable gate arrays (FPGAs).

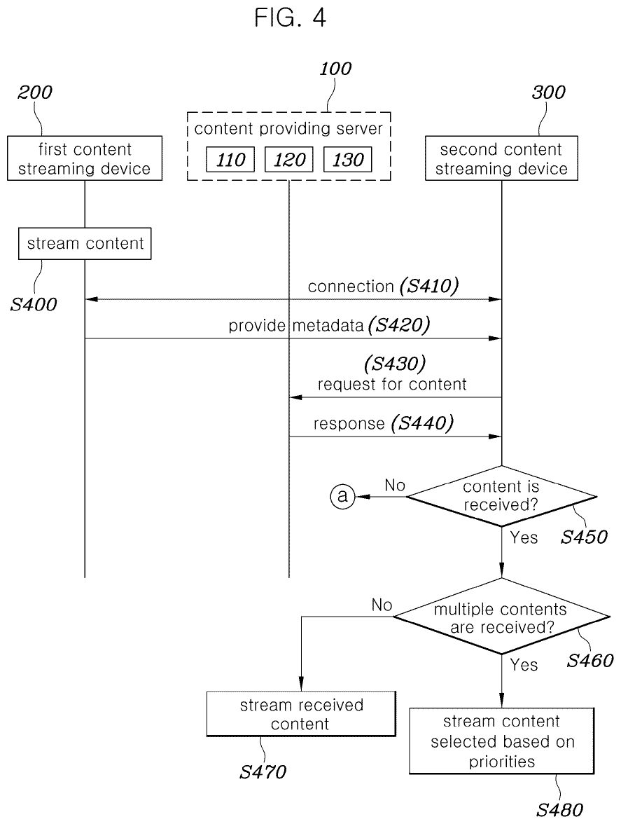

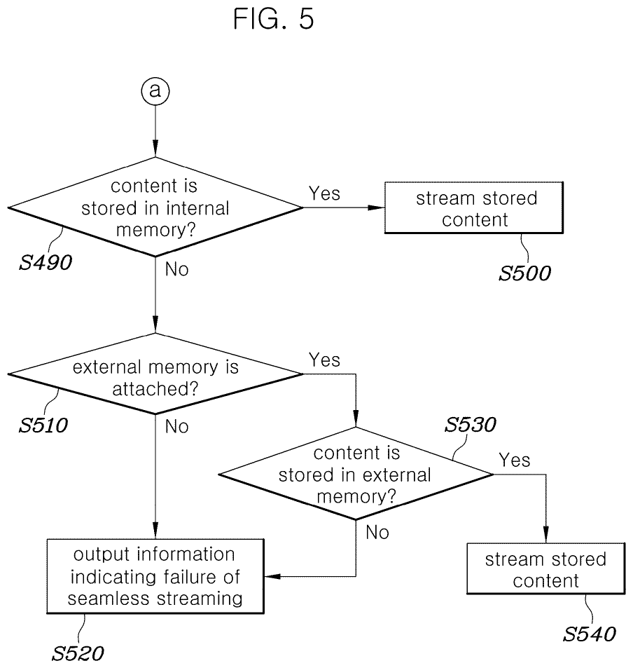

FIGS. 4 and 5 illustrate a flowchart of a method for providing seamless content streaming services between different devices according to an embodiment of the disclosure.

Hereinafter, a description is made of the method for providing seamless content streaming services between different devices according to an embodiment of the disclosure with reference to FIGS. 1 to 5.

For convenience of explanation, it is assumed that the first content streaming device 200 is streaming content provided by one of the multiple content providing servers 110, 120, and 130 and is receiving and storing content-related metadata from the content providing server supplying the content.

In addition, it is assumed that both the first content streaming device 200 and the second content streaming device 300 are set to “inter-device streaming mode.”

When the first and second content streaming devices 200 and 300 are connected at step S410 while the first content streaming device 200 is streaming content at step S400, the first content streaming device 200 may provide metadata related to the streaming content to the second content streaming device 300 at step S420.

Subsequently, the second content streaming device 300 may request streaming content at step S430 by providing metadata to at least one of the first to third content providing servers 110, 120, and 130 that constitute the content providing server 100 and are preconfigured for connection when using the service.

Subsequently, at least one of the first to third content providing servers 110, 120, and 130 that received the request may provide a response to the second content streaming device 300 at step S440.

At least one of the content providing servers that received the request at step S440 may provide either the content corresponding to the metadata or information about the failure to provide the content to the second content streaming device 300, based on whether the content corresponding to the metadata exists.

The content providing server responding at step S440 to provide the content corresponding to the metadata may provide metadata of the server.

Subsequently, the second content streaming device 300 may determine at step S450 whether content is received in response to the request.

When content is received (Yes at step S450), the second content streaming device 300 may determine at step S460 whether multiple contents are received.

When multiple contents are not received (No at step S460), meaning only one content is received, the second content streaming device 300 may stream the received content at step S470.

When multiple contents are received (Yes at step S460), the second content streaming device 300 may prioritize the multiple contents based on preconfigured prioritization information and stream the content with the highest priority at step S480.

At step S480, the second content streaming device 300 may determine whether there is second metadata with the same information as the first metadata based on the first metadata provided by the first content streaming device 200 and the second metadata matched with the received content.

When there is second metadata that contains the same information as the first metadata, the second content streaming device 300 may stream the content matched with the second metadata.

When there is no second metadata that contains the same information as the first metadata, the second content streaming device 300 may stream the content received first.

When content is not received (No at step S450), the second content streaming device 300 may search the internal memory IM based on the metadata to determine at step S490 in FIG. 5 whether the content to be streamed is stored.

When the content to be streamed is stored in the internal memory IM (Yes at step S490), the second content streaming device 300 may stream the stored content at step S500.

When the content to be streamed is not stored in the internal memory IM (No at step S490), the second content streaming device 300 may determine at step S510 whether an external memory EM is attached.

When an external memory EM is not attached (No at step S510), the second content streaming device 300 may output information indicating the failure of seamless streaming at step S520.

When an external memory EM is attached (Yes at step S510), the second content streaming device 300 may search the external memory EM to determine at step S530 whether the content to be streamed is stored.

When the content to be streamed is not stored in the external memory EM (No at step S530), the second content streaming device 300 may output information indicating the failure of seamless streaming at step S520.

When the content to be streamed is stored in the external memory EM (Yes at step S530), the second content streaming device 300 may stream the stored content at step S540.

The embodiments of the disclosure have been described in detail with reference to the accompanying drawings, but the disclosure is not limited to these embodiments and can be modified and practiced in a variety of ways without departing from the scope of the technical concept of the disclosure. Therefore, the embodiments disclosed in this specification are not intended to limit but to describe the technical idea of the disclosure, and the scope of the technical idea of the disclosure is not limited by the embodiments. Therefore, it should be understood that the embodiments described above are exemplary and not limited in all aspects. The scope of the disclosure should be interpreted in accordance with the claims set forth below, and all equivalent technical concepts should be considered as included in the scope of protection of the disclosure.

What is claimed is:

1. A content streaming device implemented to seamlessly stream content being streamed from a second content streaming device, the device comprising:
a first communication module configured to receive first metadata for the content being streamed by the second content streaming device;
a second communication module configured to communicate with a content providing server; and
a processor configured to request content corresponding to the first metadata from the content providing server and, in response to receiving content from the content providing server in response to the request, stream the received content.

2. The device of claim 1, wherein the processor is configured to receive the content from a single content providing server and stream the received content.

3. The device of claim 2, wherein the single content providing server is identical to or different from a server providing the content to the second content streaming device.

4. The device of claim 1, wherein, in response to receiving contents from multiple content providing servers, the processor is configured to stream the content that is selected based on preset priorities.

5. The device of claim 4, wherein the multiple content providing servers include or exclude a server providing the content to the second content streaming device.

6. The device of claim 4, wherein the processor is configured to compare the first metadata with second metadata received along with the content from the multiple content providing servers and stream the content that is matched with the second metadata that is identical to the first metadata.

7. The device of claim 6, wherein, in a case in which the second metadata is not identical to the first metadata, the processor is configured to stream the content received first.

8. The device of claim 1, wherein, in response to failing to receive the content from the content providing server, the processor is configured to search for the content corresponding to the first metadata in an internal memory and, in response to identifying the content corresponding to the first metadata in the internal memory, stream the content from the internal memory.

9. The device of claim 8, wherein, in response to failing to identify the content corresponding to the first metadata in the internal memory, the processor is configured to:
determine whether an external memory is attached;
in response to a determination that the external memory is attached, search for the content corresponding to the first metadata in the external memory; and
in response to identifying the content corresponding to the first metadata in the external memory, stream the content from the external memory.

10. A method for seamlessly streaming content streamed from a first content streaming device on a second content streaming device, the method comprising:
providing first metadata for the content being streamed by the first content streaming device to the second content streaming device;
requesting, at the second content streaming device, content corresponding to the first metadata from a content providing server; and
in response to the second content streaming device receiving the content from the content providing server in response to the request, streaming the received content.

11. The method of claim 10, wherein streaming the received content comprises:
receiving the content from a single content providing server; and
streaming the received content.

12. The method of claim 11, wherein the single content providing server is identical to or different from a server providing content to the first content streaming device.

13. The method of claim 10, wherein streaming the received content comprises streaming the content that is selected based on preset priorities from multiple contents provided from multiple content providing servers.

14. The method of claim 13, wherein the multiple content providing servers include or exclude a server providing content to the first content streaming device.

15. The method of claim 13, wherein streaming the content that is selected based on the preset priorities comprises:
comparing the first metadata with second metadata received along with the multiple contents provided from the multiple content providing servers; and
streaming the content that is matched with the second metadata that is identical to the first metadata.

16. The method of claim 15, wherein, in a case in which the second metadata is not identical to the first metadata, streaming the content that is selected based on the preset priorities comprises streaming the content that is received first.

17. The method of claim 10, further comprising:
in response to a failure to receive the content from the content providing server, searching, at the second content streaming device, for the content corresponding to the first metadata in an internal memory; and
in response to identifying the content in the internal memory, streaming the content from the internal memory.

18. The method of claim 17, further comprising:
in response to the content corresponding to the first metadata not being identified in the internal memory, determining, at the second content streaming device, whether an external memory is attached;
in response to a determination that the external memory is attached, searching for the content corresponding to the first metadata in the external memory; and
in response to identifying the content corresponding to the first metadata in the external memory, streaming the content from the external memory.

19. A system for providing seamless content streaming service between different devices, the system comprising:
a content providing server;
a first content streaming device configured to stream content provided by the content providing server; and
a second content streaming device, wherein the second content streaming device is configured to receive first metadata for the content being streamed by the first content streaming device, request content corresponding to the first metadata from the content providing server, and, in response to receiving the content from the content providing server in response to the request, stream the received content.

20. The system of claim 19, wherein the first content streaming device comprises a portable electronic device and the second content streaming device comprises a content delivery device installed in a vehicle.
